(19) United States
(12) Patent Application Publication
(10) Pub. No.: US 2025/0284132 A1
(43) Pub. Date: Sep. 11, 2025

(54) METHOD AND SYSTEM FOR REDUCING OPTICAL ARTIFACTS IN AUGMENTED REALITY DEVICES

(71) Applicant: Magic Leap, Inc., Plantation, FL (US)

(72) Inventors: Zachary Michael Llaneras, Miami Springs, FL (US); Jason Schaefer, Parkland, FL (US); Vikramjit Singh, Pflugerville, TX (US); Erik Heath Arend, Boulder, CO (US); Robert D. Tekolste, Black Mountain, NC (US)

(73) Assignee: Magic Leap, Inc., Plantation, FL (US)

(21) Appl. No.: 19/219,990

(22) Filed: May 27, 2025

Related U.S. Application Data
(63) Continuation of application No. PCT/US2022/051296, filed on Nov. 29, 2022.

(51) Int. Cl. G02B 27/01; G02B 25/00

(52) U.S. Cl. CPC G02B 27/0172; G02B 25/001; G02B 2027/011; G02B 2027/0127; G02B 2027/0178

(57) ABSTRACT

An augmented reality headset includes a frame and a plurality of eyepiece waveguide displays supported in the frame. Each of the plurality of eyepiece waveguide displays includes a projector and an eyepiece having a world side and a user side. The eyepiece includes one or more eyepiece waveguide layers, each of the one or more eyepiece waveguide layers including an in-coupling diffractive optical element and an out-coupling diffractive optical element. Each of the plurality of eyepiece waveguide displays also includes a first extended depth of field (EDOF) refractive element disposed adjacent the world side a dimmer assembly disposed adjacent the world side, a second EDOF refractive element disposed adjacent the user side, and an optical absorber disposed adjacent the eyepiece and overlapping in plan view with a portion of the eyepiece.

### CROSS-REFERENCE TO RELATED APPLICATIONS

This application is a continuation of International Patent Application No. PCT/US2022/051296, filed Nov. 29, 2022, entitled “METHOD AND SYSTEM FOR REDUCING OPTICAL ARTIFACTS IN AUGMENTED REALITY DEVICES,” the entire disclosure of which is hereby incorporated by reference, for all purposes, as if fully set forth herein.

### BACKGROUND OF THE INVENTION

Modern computing and display technologies have facilitated the development of systems for so-called “virtual reality” or “augmented reality” experiences, wherein digitally reproduced images or portions thereof are presented to a viewer in a manner wherein they seem to be, or may be perceived as, real. A virtual reality, or “VR,” scenario typically involves presentation of digital or virtual image information without transparency to other actual real-world visual input; an augmented reality, or “AR,” scenario typically involves presentation of digital or virtual image information as an augmentation to visualization of the actual world around the viewer.

Referring to FIG. 1, an augmented reality scene 100 is depicted. The user of an AR technology sees a real-world park-like setting featuring people, trees, buildings in the background, and a concrete platform 120. The user also perceives that he/she “sees” “virtual content” such as a robot statue 110 standing upon the real-world concrete platform 120, and a flying cartoon-like avatar character 102 which seems to be a personification of a bumble bee. These elements 110 and 102 are “virtual” in that they do not exist in the real world. Because the human visual perception system is complex, it is challenging to produce AR technology that facilitates a comfortable, natural-feeling, rich presentation of virtual image elements amongst other virtual or real-world imagery elements.

Despite the progress made in these display technologies, there is a need in the art for improved methods and systems related to augmented reality systems, particularly, display systems.

### SUMMARY OF THE INVENTION

The present invention relates generally to methods and systems related to projection display systems including wearable displays. More particularly, embodiments of the present invention provide methods and systems for reducing light artifacts in augmented reality systems. The invention is applicable to a variety of applications in computer vision and image display systems.

In some AR waveguide display systems, strong angular light artifacts can be present, particularly in systems that are characterized by a large active waveguide area. As an example, artifacts due to back reflections from the elements of the waveguide display can degrade the user experience. As described herein, embodiments of the present invention utilize a circular polarizer, a visible color absorptive, anti-reflective film, or the like in order to reduce the light artifacts produced at high angles and increase the user's see-through experience.

According to an embodiment of the present invention, an augmented reality (AR) headset is provided. The AR headset includes a frame and a plurality of eyepiece waveguide displays supported in the frame. Each of the plurality of eyepiece waveguide displays includes a projector and an eyepiece having a world side and a user side. The eyepiece includes one or more eyepiece waveguide layers, each of the one or more eyepiece waveguide layers including an in-coupling diffractive optical element and an out-coupling diffractive optical element. Each of the plurality of eyepiece waveguide displays also includes a first extended depth of field (EDOF) refractive element disposed adjacent the world side, a dimmer assembly disposed adjacent the world side, a second EDOF refractive element disposed adjacent the user side, and an optical absorber disposed adjacent the eyepiece and overlapping in plan view with a portion of the eyepiece.

The eyepiece can include a nasal region and a peripheral region. The portion of the eyepiece can be the peripheral region. The nasal region can be free of the optical absorber. The optical absorber can be disposed adjacent the user side of the eyepiece. The optical absorber can include a circular polarizer including a linear polarizer and a quarter waveplate. The optical absorber can include a neutral density filter. The optical absorber can include an optical element configured to absorb visible light. The optical absorber can include an electrochromic element. The eyepiece can have a world aperture operable to pass world light and the optical absorber can overlap with the world aperture in plan view. The eyepiece can be disposed in a lateral plane and operable to pass world light through a world aperture defined by a predetermined area of the lateral plane. The predetermined area can include a lateral position and a region of the optical absorber can be positioned at the lateral position.

According to another embodiment of the present invention, a method of mitigating artifacts in an AR headset is provided. The method includes generating virtual content using a visible optics assembly of the augmented reality headset. The visible optics assembly includes an eyepiece having a world side and a user side. The method also includes emitting the virtual content from the user side of the eyepiece toward a user, receiving incident light directed toward the user side of the eyepiece, and passing a portion of the incident light through a circular polarizer. The method further includes reflecting a fraction of the portion of the incident light from the visible optical assembly and absorbing the fraction of the portion of the incident light at the circular polarizer.

The portion of the incident light can be passed through the circular polarizer at a peripheral region of the eyepiece. Reflecting the fraction of the portion of the incident light from the visible optical assembly can include reflecting the fraction of the portion of the incident light from the eyepiece. The eyepiece can include a nasal region and a peripheral region. The circular polarizer can overlap in plan view with the peripheral region. The circular polarizer can be disposed adjacent the user side of the eyepiece. The circular polarizer can include a linear polarizer and a quarter waveplate.

Numerous benefits are achieved by way of the present invention over conventional techniques. For example, embodiments of the present invention provide methods and systems that can reduce reflection of light from the eyepiece, thereby improving the user experience. As an example, the intensity of light that originates from locations behind the user and would otherwise reflect off one or more surfaces of the eyepiece waveguide display toward the user can be reduced, thereby enabling the user to view world light more clearly. These and other embodiments of the invention along with many of its advantages and features are described in more detail in conjunction with the text below and attached figures.

### BRIEF DESCRIPTION OF THE DRAWINGS

FIG. 1 illustrates a user's view of augmented reality (AR) through an AR device.

FIG. 2A illustrates a cross-sectional side view of an example of a set of stacked waveguides that each includes an incoupling optical element.

FIG. 2B illustrates a perspective view of an example of the one or more stacked waveguides of FIG. 2A.

FIG. 2C illustrates a top-down plan view of an example of the one or more stacked waveguides of FIGS. 2A and 2B.

FIG. 2D illustrates an example of wearable display system according to an embodiment of the present invention.

FIG. 2E is a simplified illustration of an eyepiece waveguide having a combined pupil expander according to an embodiment of the present invention.

FIG. 3 shows a perspective view of a wearable device according to an embodiment of the present invention.

FIG. 4A is a simplified image illustrating an initial view of an environment according to an embodiment of the present invention.

FIG. 4B is a simplified image illustrating another view of the environment illustrated in FIG. 4A with an eyepiece and artifacts according to an embodiment of the present invention.

FIG. 5A is a simplified plan view of a user and an AR headset according to an embodiment of the present invention.

FIG. 5B is a simplified plan view of artifact mitigation using a circular polarizer according to an embodiment of the present invention.

FIG. 6A is a simplified plan view of an eyepiece according to an embodiment of the present invention.

FIG. 6B is a simplified plan view of the eyepiece illustrated in FIG. 6A and a circular polarizer according to an embodiment of the present invention.

FIG. 7 is a simplified plan view of elements of an AR headset including artifact mitigation according to an embodiment of the present invention.

FIG. 8 is an exploded perspective view of elements of an AR headset including artifact mitigation according to an embodiment of the present invention.

FIG. 9A is a simplified plan view of an AR headset including an attenuating film according to an embodiment of the present invention.

FIG. 9B is a simplified perspective view of an AR headset set including one or more light absorbing films according to an embodiment of the present invention.

FIG. 10 is a simplified block diagram illustrating components of an AR system according to an embodiment of the present invention.

FIG. 11 is a simplified flowchart illustrating a method of operating an AR system according to an embodiment of the present invention.

FIG. 12 is a cross sectional view of an exemplary electrochromic optical component 1200 according to an embodiment of the present invention.

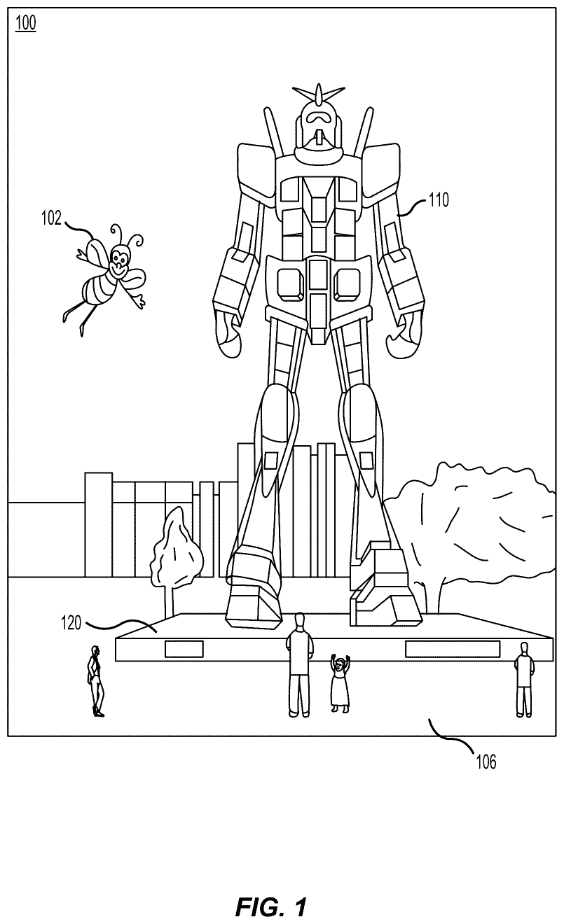

### DETAILED DESCRIPTION OF SPECIFIC EMBODIMENTS

Reference will now be made to the drawings, in which like reference numerals refer to like parts throughout. Unless indicated otherwise, the drawings are schematic not necessarily drawn to scale.

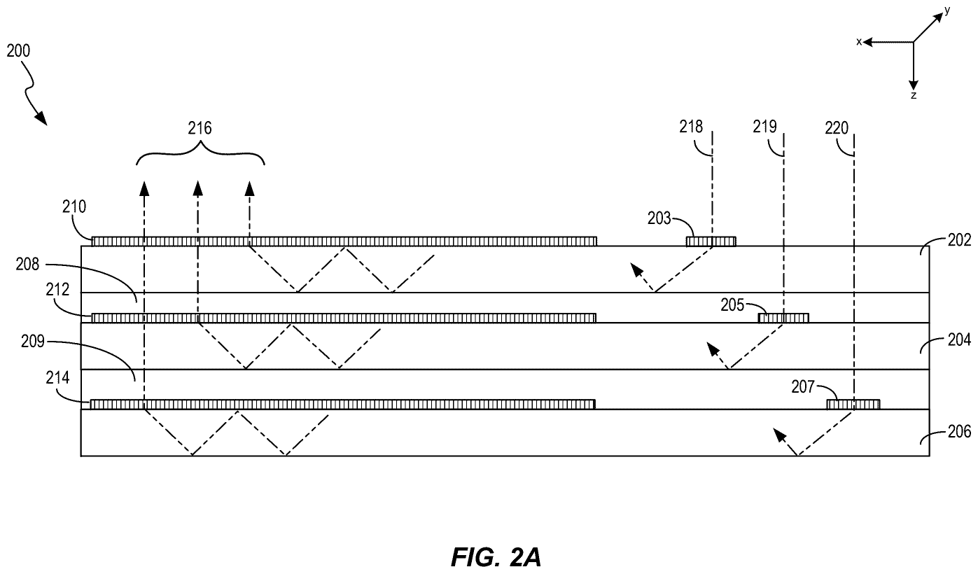

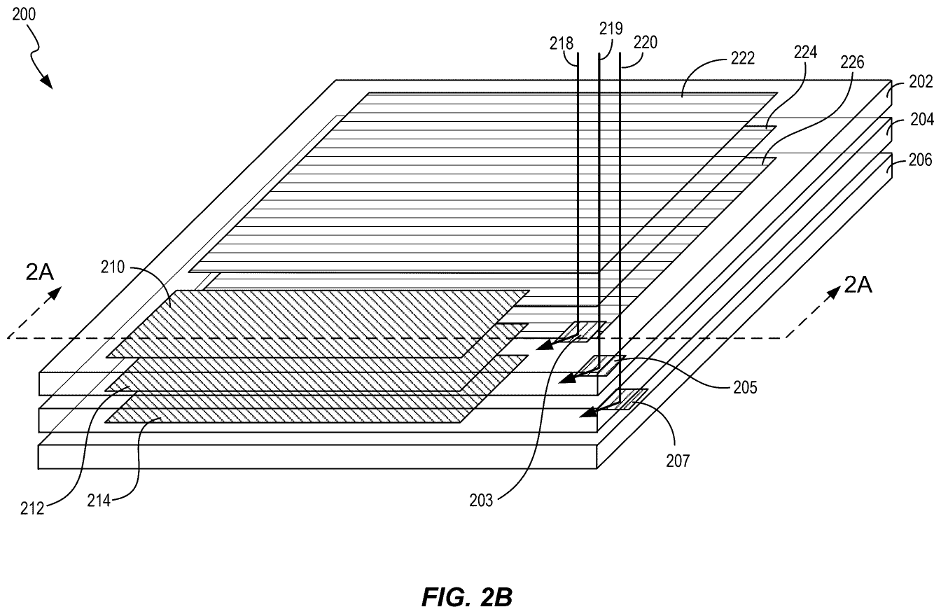

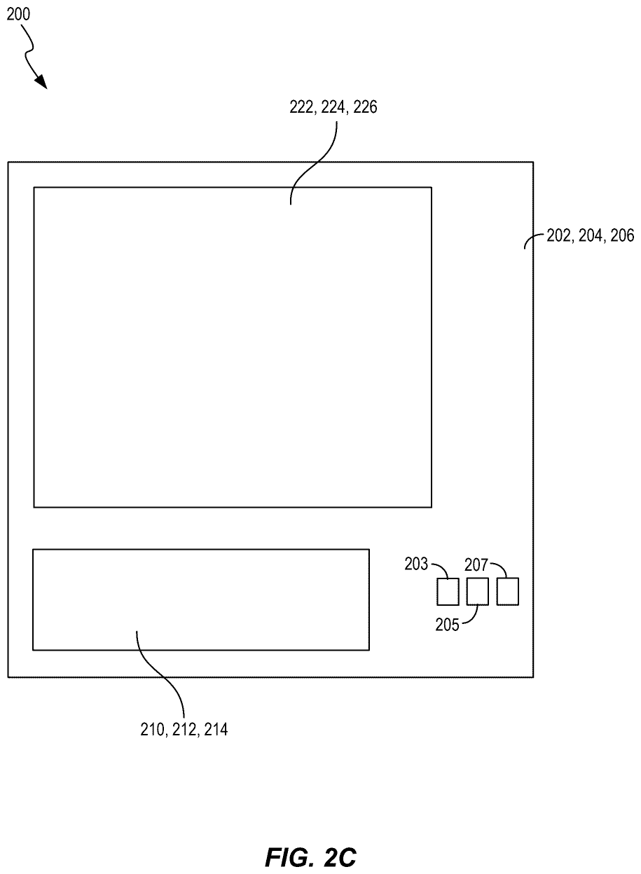

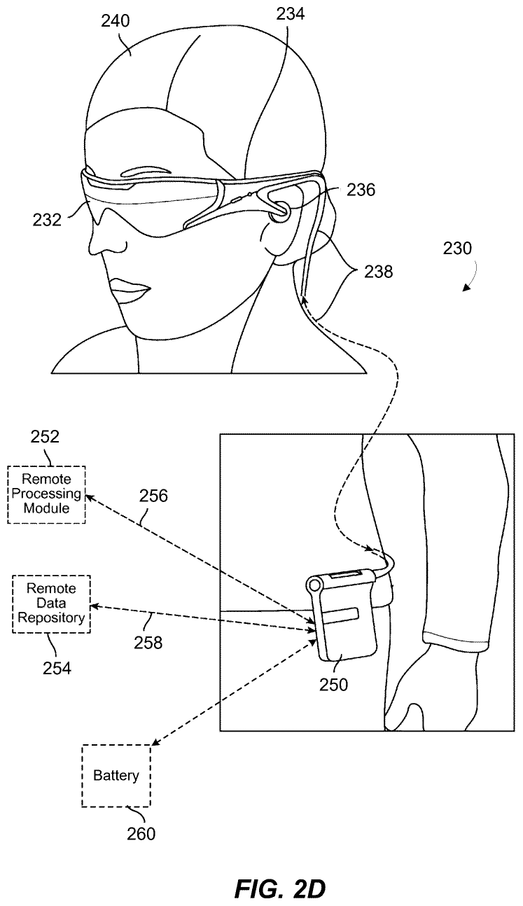

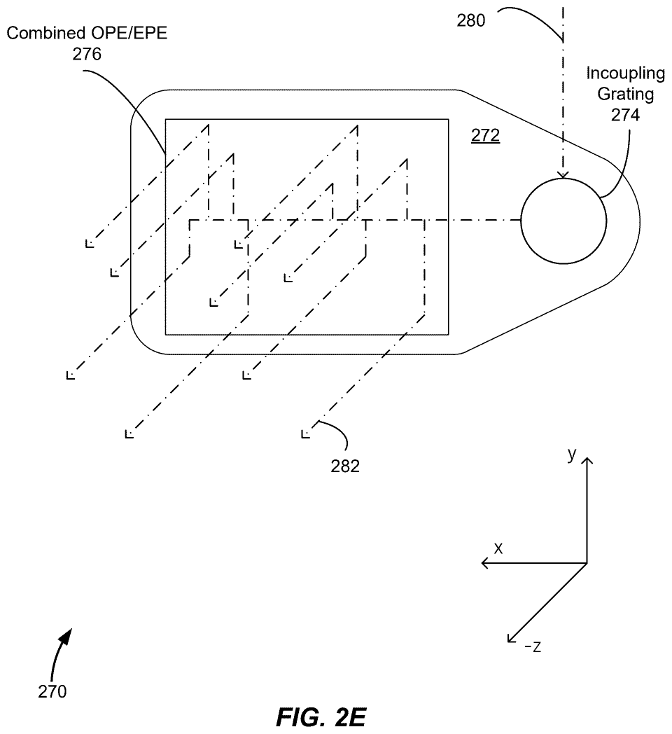

With reference now to FIG. 2A, in some embodiments, light impinging on a waveguide may need to be redirected to incouple that light into the waveguide. An incoupling optical element may be used to redirect and in-couple the light into its corresponding waveguide. Although referred to as “incoupling optical element” through the specification, the incoupling optical element need not be an optical element and may be a non-optical element. FIG. 2A illustrates a cross-sectional side view of an example of a set 200 of stacked waveguides that each includes an incoupling optical element. The waveguides may each be configured to output light of one or more different wavelengths, or one or more different ranges of wavelengths. Light from a projector is injected into the set 200 of stacked waveguides and outcoupled to a user as described more fully below.

The illustrated set 200 of stacked waveguides includes waveguides 202, 204, and 206. Each waveguide includes an associated incoupling optical element (which may also be referred to as a light input area on the waveguide), with, e.g., incoupling optical element 203 disposed on a major surface (e.g., an upper major surface) of waveguide 202, incoupling optical element 205 disposed on a major surface (e.g., an upper major surface) of waveguide 204, and incoupling optical element 207 disposed on a major surface (e.g., an upper major surface) of waveguide 206. In some embodiments, one or more of the incoupling optical elements 203, 205, 207 may be disposed on the bottom major surface of the respective waveguides 202, 204, 206 (particularly where the one or more incoupling optical elements are reflective, deflecting optical elements). As illustrated, the incoupling optical elements 203, 205, 207 may be disposed on the upper major surface of their respective waveguide 202, 204, 206 (or the top of the next lower waveguide), particularly where those incoupling optical elements are transmissive, deflecting optical elements. In some embodiments, the incoupling optical elements 203, 205, 207 may be disposed in the body of the respective waveguide 202, 204, 206. In some embodiments, as discussed herein, the incoupling optical elements 203, 205, 207 are wavelength-selective, such that they selectively redirect one or more wavelengths of light, while transmitting other wavelengths of light. While illustrated on one side or corner of their respective waveguides 202, 204, 206, it will be appreciated that the incoupling optical elements 203, 205, 207 may be disposed in other areas of their respective waveguides 202, 204, 206 in some embodiments.

As illustrated, the incoupling optical elements 203, 205, 207 may be laterally offset from one another. In some embodiments, each incoupling optical element may be offset such that it receives light without that light passing through another incoupling optical element. For example, each incoupling optical element 203, 205, 207 may be configured to receive light from a different projector and may be separated (e.g., laterally spaced apart) from other incoupling optical elements 203, 205, 207 such that it substantially does not receive light from the other ones of the incoupling optical elements 203, 205, 207.

Each waveguide also includes associated light distributing elements, with, e.g., light distributing elements 210 disposed on a major surface (e.g., a top major surface) of waveguide 202, light distributing elements 212 disposed on a major surface (e.g., a top major surface) of waveguide 204, and light distributing elements 214 disposed on a major surface (e.g., a top major surface) of waveguide 206. In some other embodiments, the light distributing elements 210, 212, 214 may be disposed on a bottom major surface of associated waveguides 202, 204, 206, respectively. In some other embodiments, the light distributing elements 210, 212, 214 may be disposed on both top and bottom major surfaces of associated waveguides 202, 204, 206, respectively; or the light distributing elements 210, 212, 214 may be disposed on different ones of the top and bottom major surfaces in different associated waveguides 202, 204, 206, respectively.

The waveguides 202, 204, 206 may be spaced apart and separated by, e.g., gas, liquid, and/or solid layers of material. For example, as illustrated, layer 208 may separate waveguides 202 and 204; and layer 209 may separate waveguides 204 and 206. In some embodiments, the layers 208 and 209 are formed of low refractive index materials (that is, materials having a lower refractive index than the material forming the immediately adjacent one of waveguides 202, 204, 206). Preferably, the refractive index of the material forming the layers 208, 209 is 0.05 or more, or 0.10 or less than the refractive index of the material forming the waveguides 202, 204, 206. Advantageously, the lower refractive index layers 208, 209 may function as cladding layers that facilitate total internal reflection (TIR) of light through the waveguides 202, 204, 206 (e.g., TIR between the top and bottom major surfaces of each waveguide). In some embodiments, the layers 208, 209 are formed of air. While not illustrated, it will be appreciated that the top and bottom of the illustrated set 200 of waveguides may include immediately neighboring cladding layers.

Preferably, for ease of manufacturing and other considerations, the material forming the waveguides 202, 204, 206 are similar or the same, and the material forming the layers 208, 209 are similar or the same. In some embodiments, the material forming the waveguides 202, 204, 206 may be different between one or more waveguides, and/or the material forming the layers 208, 209 may be different, while still holding to the various refractive index relationships noted above.

With continued reference to FIG. 2A, light rays 218, 219, 220 are incident on the set 200 of waveguides. It will be appreciated that the light rays 218, 219, 220 may be injected into the waveguides 202, 204, 206 by one or more projectors (not shown).

In some embodiments, the light rays 218, 219, 220 have different properties, e.g., different wavelengths or different ranges of wavelengths, which may correspond to different colors. The incoupling optical elements 203, 205, 207 each deflect the incident light such that the light propagates through a respective one of the waveguides 202, 204, 206 by TIR. In some embodiments, the incoupling optical elements 203, 205, 207 each selectively deflect one or more particular wavelengths of light, while transmitting other wavelengths to an underlying waveguide and associated incoupling optical element.

For example, incoupling optical element 203 may be configured to deflect ray 218, which has a first wavelength or range of wavelengths, while transmitting rays 219 and 220, which have different second and third wavelengths or ranges of wavelengths, respectively. The transmitted ray 219 impinges on and is deflected by the incoupling optical element 205, which is configured to deflect light of a second wavelength or range of wavelengths. The ray 220 is deflected by the incoupling optical element 207, which is configured to selectively deflect light of third wavelength or range of wavelengths.

With continued reference to FIG. 2A, the deflected light rays 218, 219, 220 are deflected so that they propagate through a corresponding waveguide 202, 204, 206; that is, the incoupling optical elements 203, 205, 207 of each waveguide deflects light into that corresponding waveguide 202, 204, 206 to in-couple light into that corresponding waveguide. The light rays 218, 219, 220 are deflected at angles that cause the light to propagate through the respective waveguide 202, 204, 206 by TIR. The light rays 218, 219, 220 propagate through the respective waveguide 202, 204, 206 by TIR until impinging on the waveguide's corresponding light distributing elements 210, 212, 214, where they are outcoupled to provide out-coupled light rays 216.

With reference now to FIG. 2B, a perspective view of an example of the stacked waveguides of FIG. 2A is illustrated. As noted above, the in-coupled light rays 218, 219, 220, are deflected by the incoupling optical elements 203, 205, 207, respectively, and then propagate by TIR within the waveguides 202, 204, 206, respectively. The light rays 218, 219, 220 then impinge on the light distributing elements 210, 212, 214, respectively. The light distributing elements 210, 212, 214 deflect the light rays 218, 219, 220 so that they propagate towards the outcoupling optical elements 222, 224, 226, respectively.

In some embodiments, the light distributing elements 210, 212, 214 are orthogonal pupil expanders (OPEs). In some embodiments, the OPEs deflect or distribute light to the outcoupling optical elements 222, 224, 226 and, in some embodiments, may also increase the beam or spot size of this light as it propagates to the outcoupling optical elements. In some embodiments, the light distributing elements 210, 212, 214 may be omitted and the incoupling optical elements 203, 205, 207 may be configured to deflect light directly to the outcoupling optical elements 222, 224, 226. For example, with reference to FIG. 2A, the light distributing elements 210, 212, 214 may be replaced with outcoupling optical elements 222, 224, 226, respectively. In some embodiments, the outcoupling optical elements 222, 224, 226 are exit pupils (EPs) or exit pupil expanders (EPEs) that direct light to the eye of the user. It will be appreciated that the OPEs may be configured to increase the dimensions of the eye box in at least one axis and the EPEs may be configured to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EPE again, at which time another portion of the impinging light is directed out of the waveguide, and so on. Consequently, a single beam of in-coupled light may be “replicated” each time a portion of that light is redirected by an OPE or EPE, thereby forming a field of cloned beams of light. In some embodiments, the OPE and/or EPE may be configured to modify a size of the beams of light. In some embodiments, the functionality of the light distributing elements 210, 212, and 214 and the outcoupling optical elements 222, 224, 226 are combined in a combined pupil expander as discussed in relation to FIG. 2E.

Accordingly, with reference to FIGS. 2A and 2B, in some embodiments, the set 200 of waveguides includes waveguides 202, 204, 206; incoupling optical elements 203, 205, 207; light distributing elements (e.g., OPEs) 210, 212, 214; and outcoupling optical elements (e.g., EPs) 222, 224, 226 for each component color. The waveguides 202, 204, 206 may be stacked with an air gap/cladding layer between each one. The incoupling optical elements 203, 205, 207 redirect or deflect incident light (with different incoupling optical elements receiving light of different wavelengths) into its waveguide. The light then propagates at an angle which will result in TIR within the respective waveguide 202, 204, 206. In the example shown, light ray 218 (e.g., blue light) is deflected by the first incoupling optical element 203, and then continues to bounce down the waveguide, interacting with the light distributing element (e.g., OPEs) 210 and then the outcoupling optical element (e.g., EPs) 222, in a manner described earlier. The light rays 219 and 220 (e.g., green and red light, respectively) will pass through the waveguide 202, with light ray 219 impinging on and being deflected by incoupling optical element 205. The light ray 219 then bounces down the waveguide 204 via TIR, proceeding on to its light distributing element (e.g., OPEs) 212 and then the outcoupling optical element (e.g., EPs) 224. Finally, light ray 220 (e.g., red light) passes through the waveguide 206 to impinge on the light incoupling optical elements 207 of the waveguide 206. The light incoupling optical elements 207 deflect the light ray 220 such that the light ray propagates to light distributing element (e.g., OPEs) 214 by TIR, and then to the outcoupling optical element (e.g., EPs) 226 by TIR. The outcoupling optical element 226 then finally out-couples the light ray 220 to the viewer, who also receives the outcoupled light from the other waveguides 202, 204.

FIG. 2C illustrates a top-down plan view of an example of the stacked waveguides of FIGS. 2A and 2B. As illustrated, the waveguides 202, 204, 206, along with each waveguide's associated light distributing element 210, 212, 214 and associated outcoupling optical element 222, 224, 226, may be vertically aligned. However, as discussed herein, the incoupling optical elements 203, 205, 207 are not vertically aligned; rather, the incoupling optical elements are preferably nonoverlapping (e.g., laterally spaced apart as seen in the top-down or plan view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially separated incoupling optical elements may be referred to as a shifted pupil system, and the incoupling optical elements within these arrangements may correspond to sub pupils.

FIG. 2D illustrates an example of wearable display system 230 into which the various waveguides and related systems disclosed herein may be integrated. With reference to FIG. 2D, the display system 230 includes a display 232, and various mechanical and electronic modules and systems to support the functioning of that display 232. The display 232 may be coupled to a frame 234, which is wearable by a display system user 240 (also referred to as a viewer) and which is configured to position the display 232 in front of the eyes of the user 240. The display 232 may be considered eyewear in some embodiments. In some embodiments, a speaker 236 is coupled to the frame 234 and configured to be positioned adjacent the ear canal of the user 240 (in some embodiments, another speaker, not shown, may optionally be positioned adjacent the other ear canal of the user to provide stereo/shapeable sound control). The display system 230 may also include one or more microphones or other devices to detect sound. In some embodiments, the microphone is configured to allow the user to provide inputs or commands to the system 230 (e.g., the selection of voice menu commands, natural language questions, etc.), and/or may allow audio communication with other persons (e.g., with other users of similar display systems). The microphone may further be configured as a peripheral sensor to collect audio data (e.g., sounds from the user and/or environment). In some embodiments, the display system 230 may further include one or more outwardly directed environmental sensors configured to detect objects, stimuli, people, animals, locations, or other aspects of the world around the user. For example, environmental sensors may include one or more cameras, which may be located, for example, facing outward so as to capture images similar to at least a portion of an ordinary field of view of the user 240. In some embodiments, the display system may also include a peripheral sensor, which may be separate from the frame 234 and attached to the body of the user 240 (e.g., on the head, torso, an extremity, etc. of the user 240). The peripheral sensor may be configured to acquire data characterizing a physiological state of the user 240 in some embodiments. For example, the sensor may be an electrode.

The display 232 is operatively coupled by a communications link, such as by a wired lead or wireless connectivity, to a local data processing module which may be mounted in a variety of configurations, such as fixedly attached to the frame 234, fixedly attached to a helmet or hat worn by the user, embedded in headphones, or otherwise removably attached to the user 240 (e.g., in a backpack-style configuration, in a belt-coupling style configuration). Similarly, the sensor may be operatively coupled by a communications link, e.g., a wired lead or wireless connectivity, to the local processor and data module. The local processing and data module may comprise a hardware processor, as well as digital memory, such as non-volatile memory (e.g., flash memory or hard disk drives), both of which may be utilized to assist in the processing, caching, and storage of data. Optionally, the local processor and data module may include one or more central processing units (CPUs), graphics processing units (GPUs), dedicated processing hardware, and so on. The data may include data a) captured from sensors (which may be, e.g., operatively coupled to the frame 234 or otherwise attached to the user 240), such as image capture devices (such as cameras), microphones, inertial measurement units, accelerometers, compasses, GPS units, radio devices, gyros, and/or other sensors disclosed herein; and/or b) acquired and/or processed using remote processing module 252 and/or remote data repository 254 (including data relating to virtual content), possibly for passage to the display 232 after such processing or retrieval. The local processing and data module may be operatively coupled by communication links 238 such as via wired or wireless communication links, to the remote processing and data module 250, which can include the remote processing module 252, the remote data repository 254, and a battery 260. The remote processing module 252 and the remote data repository 254 can be coupled by communication links 256 and 258 to remote processing and data module 250 such that these remote modules are operatively coupled to each other and available as resources to the remote processing and data module 250. In some embodiments, the remote processing and data module 250 may include one or more of the image capture devices, microphones, inertial measurement units, accelerometers, compasses, GPS units, radio devices, and/or gyros. In some other embodiments, one or more of these sensors may be attached to the frame 234, or may be standalone structures that communicate with the remote processing and data module 250 by wired or wireless communication pathways.

With continued reference to FIG. 2D, in some embodiments, the remote processing and data module 250 may comprise one or more processors configured to analyze and process data and/or image information, for instance including one or more central processing units (CPUs), graphics processing units (GPUs), dedicated processing hardware, and so on. In some embodiments, the remote data repository 254 may comprise a digital data storage facility, which may be available through the internet or other networking configuration in a “cloud” resource configuration. In some embodiments, the remote data repository 254 may include one or more remote servers, which provide information, e.g., information for generating augmented reality content, to the local processing and data module and/or the remote processing and data module 250. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, the illustrated modules, for instance, via wireless or wired connections.

FIG. 2E is a simplified illustration of an eyepiece waveguide having a combined pupil expander according to an embodiment of the present invention. In the example illustrated in FIG. 2E, the eyepiece 270 utilizes a combined OPE/EPE region in a single-side configuration. Referring to FIG. 2E, the eyepiece 270 includes a substrate 272 in which in-coupling optical element 274 and a combined OPE/EPE region 276, also referred to as a combined pupil expander (CPE), are provided. Incident light ray 280 is incoupled via the incoupling optical element 274 and outcoupled as output light rays 282 via the combined OPE/EPE region 276.

The combined OPE/EPE region 276 includes gratings corresponding to both an OPE and an EPE that spatially overlap in the x-direction and the y-direction. In some embodiments, the gratings corresponding to both the OPE and the EPE are located on the same side of a substrate 272 such that either the OPE gratings are superimposed onto the EPE gratings or the EPE gratings are superimposed onto the OPE gratings (or both). In other embodiments, the OPE gratings are located on the opposite side of the substrate 272 from the EPE gratings such that the gratings spatially overlap in the x-direction and the y-direction but are separated from each other in the z-direction (i.e., in different planes). Thus, the combined OPE/EPE region 276 can be implemented in either a single-sided configuration or in a two-sided configuration.

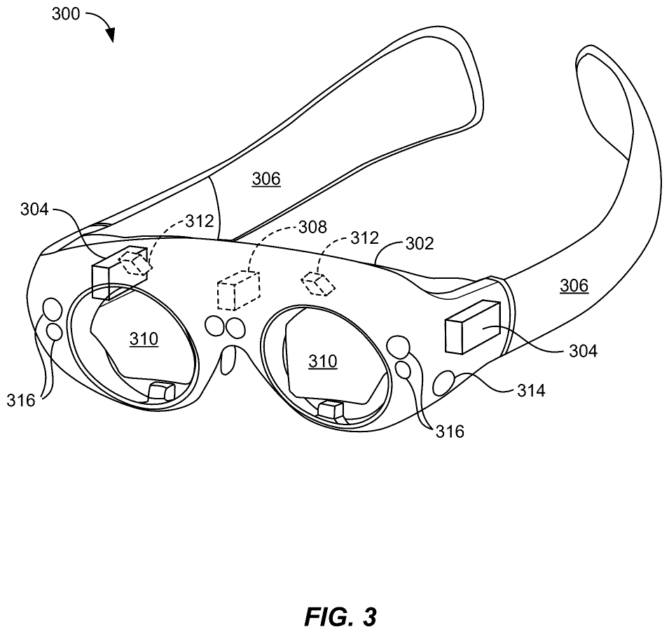

FIG. 3 shows a perspective view of a wearable device 300 according to an embodiment of the present invention. Wearable device 300 includes a frame 302 configured to support one or more projectors 304 at various positions along an interior-facing surface of frame 302, as illustrated. In some embodiments, projectors 304 can be attached at positions near temples 306. Alternatively, or in addition, another projector could be placed in position 308. Such projectors may, for instance, include or operate in conjunction with one or more liquid crystal on silicon (LCoS) modules, micro-LED displays, or fiber scanning devices. In some embodiments, light from projectors 304 or projectors disposed in positions 308 could be guided into eyepieces 310 for display to eyes of a user. Projectors placed at positions 312 can be somewhat smaller on account of the close proximity this gives the projectors to the waveguide system. The closer proximity can reduce the amount of light lost as the waveguide system guides light from the projectors to eyepiece 310. In some embodiments, the projectors at positions 312 can be utilized in conjunction with projectors 304 or projectors disposed in positions 308. While not depicted, in some embodiments, projectors could also be located at positions beneath eyepieces 310. Wearable device 300 is also depicted including sensors 314 and 316. Sensors 314 and 316 can take the form of forward-facing and lateral-facing optical sensors configured to characterize the real-world environment surrounding wearable device 300.

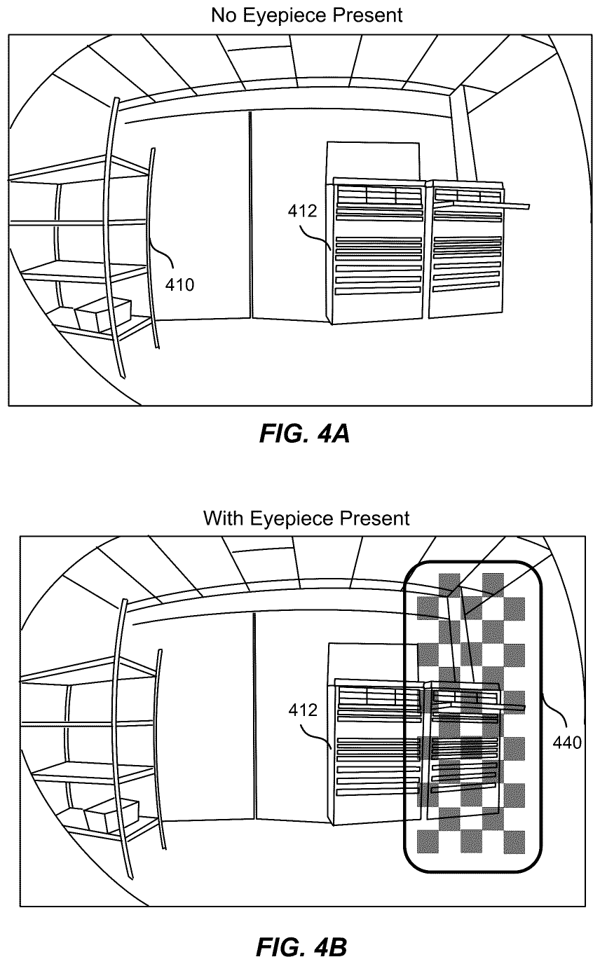

FIG. 4A is a simplified image illustrating an initial view of an environment according to an embodiment of the present invention. The initial view illustrated in FIG. 4A is taken through a right eyepiece, with the nasal region represented by the left side of the image and the temple or peripheral region represented by the right side of the image. A similar image would be produced by the eyepiece corresponding to the user's left eye. As shown in FIG. 4A, the eyepiece is characterized by a large field of view, extending approximately 53°×53°, for example, 55°×55°, in both the nasal and peripheral directions. With no eyepiece present, a rack of equipment 410 and a set of equipment cabinets 412 are visible. Although not visible in FIG. 4A, a checkerboard calibration pattern is present behind and to the right of the eyepiece.

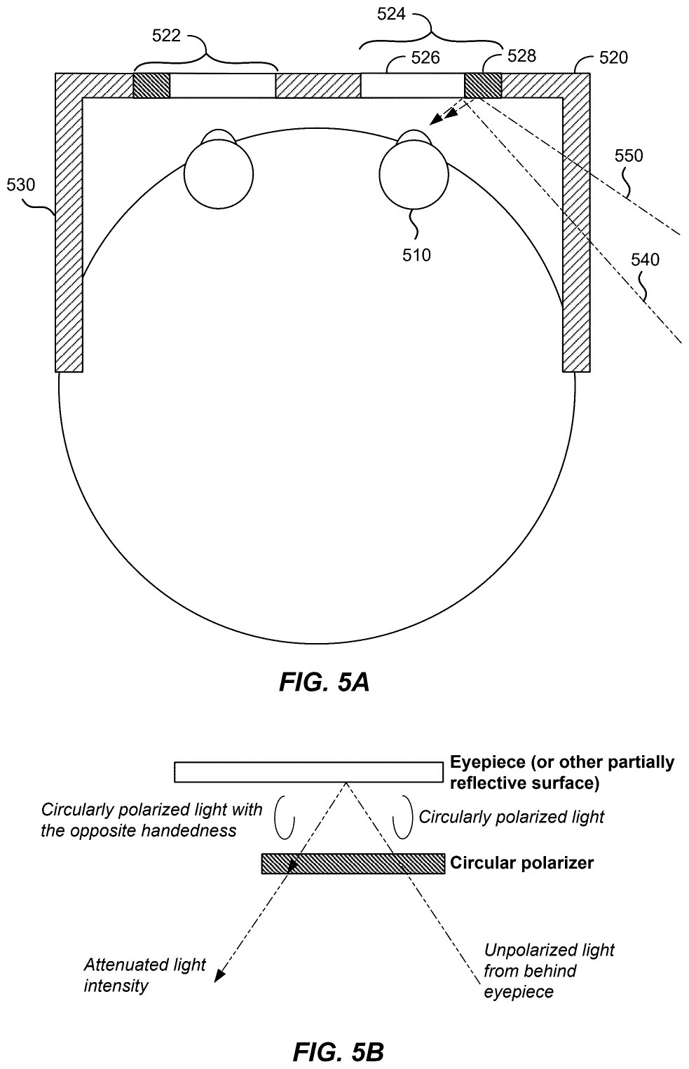

FIG. 4B is a simplified image illustrating another view of the environment illustrated in FIG. 4A with an eyepiece and artifacts according to an embodiment of the present invention. As illustrated in FIG. 4B, peripheral region 440 includes a reflection of the checkerboard calibration pattern present behind and to the right of the eyepiece. Since the eyepiece has a large field of view, specular reflection of light propagating from locations behind the eyepiece like that present in peripheral region 440 are observed on the temple or peripheral side of the user's field of view as illustrated by the checkerboard pattern in peripheral region 440. These reflections, which can also be referred to as back reflections, are seen by users when wearing an AR headset including the eyepiece. As a result, the reflection of light associated with the checkerboard calibration pattern can be as bright or brighter than light incident on the eyepiece from the locations in front of the user, for example, light reflected from the set of equipment cabinets 412 located in front of the eyepiece. As described more fully in relation to FIG. 5A, light reflected from the checkerboard calibration pattern positioned behind and to the right of the user propagates forward towards the eyepiece, reflects from one or more elements present in the eyepiece, and is directed toward the user's eye as a specular reflection, thereby presenting the image shown in FIG. 4B to the user.

To accommodate the higher FOV, high index glass (>1.8 refractive index in the visible spectrum) is typically used for the optical waveguides. Reflectance increases with the index of the glass, and as a result multiple layers of high index glass can be expected to produce reflection levels higher than that seen in conventional glasses. The inventors have determined that the high reflection values significantly degrade the user experience when the user is looking through the AR headset including the eyepiece since elements of the eyepiece produce a mirror effect by which the user can see a portion or all of the scene that is located behind the user, for example, directly behind the user as illustrated in FIG. 4B.

FIG. 5A is a simplified plan view of a user and an AR headset according to an embodiment of the present invention. In the plan view illustrated in FIG. 5A, the head of a user is illustrated including right eye 510 with AR headset 520 positioned on the user's head. The AR headset 520 includes left eyepiece 522 and a corresponding right eyepiece 524 that includes central region 526 and peripheral region 528. Referring to FIGS. 4A and 4B, central region 526 can correspond to the center and left side of the image shown in FIGS. 4A and 4B and peripheral region 528 can correspond to peripheral region 440. Light passing past the temple 530 of AR headset 520 from locations behind and to the right of the user reflects from peripheral region 528 and is reflected toward right eye 510 as illustrated by light ray 540 at a first angle of incidence and light ray 550 at a second angle of incidence larger than the first angle of incidence. Thus, as shown by the example illustrated in FIG. 4B, light reflected from or emitted by items behind and to the right of the user propagates forward towards the eyepiece, is reflected from peripheral region 528 and is directed toward the user's eye as a specular reflection. This specular reflection combines with light from the locations in front of the user, potentially interfering with the user's view of location in front of the user. Merely by way of example, if the transmittance of the eyepiece is 20% and the reflectance in peripheral region 528 is 30%, then the amount of light corresponding to the artifact will be greater than the amount of desirable light corresponding to the locations the user is viewing since the transmittance/reflectance ratio is less than unity. Accordingly, embodiments of the present invention reduce the reflectance in the peripheral region, thereby increasing the transmittance/reflectance ratio and improving the user's experience.

FIG. 5B is a simplified plan view of artifact mitigation using a circular polarizer according to an embodiment of the present invention. As illustrated in FIG. 5B, the principle of how a circular polarizer reduces the brightness of reflections reaching the user's eye is shown. Referring to FIG. 5B, unpolarized light from locations behind and to the right of the user is incident on the temple side of the system. Without the circular polarizer in place, as discussed in relation to FIG. 4B, this light will reflect off of the eyepiece, or other optical component, and then be visible to the user as a potentially bright reflection. With the circular polarizer in place as shown in FIG. 5B, the unpolarized light that passes through the circular polarizer becomes circularly polarized. When this circularly polarized light reflects off of the eyepiece, or other optical component, the handedness of the circular polarization changes to the opposite handedness. Thus, when the reflected light with opposite handedness reaches the circular polarizer a second time, it is attenuated by the circular polarizer, since ideally, the circular polarizer does not pass light having this opposite handedness. Thus, the insertion of the circular polarizer along the optical path extending from the location behind and to the right of the user to the user reduces or prevents light propagating along this optical path from reaching the user.

The circular polarizer can be fabricated using materials compatible with angle optimization to improve off-axis performance. When using circular polarizers to act as optical isolators, the ellipticity of the polarization state exiting the circular polarizer may not be constant with respect to the incident angle. This can lead to a change in isolation performance vs incident angle. View Angle compensation films can be used in conjunction with the base circular polarization to alter/optimize the isolation performance of the circular polarizer. View angle compensation films use out of plane retardance in order to adjust the ellipticity of the higher angles of incidence. These films are commonly referred to as C-plates. Thus, by choosing the appropriate out of plane retardance value, the isolation can be tuned for specific wavelengths and/or angles that contribute negatively to the user experience.

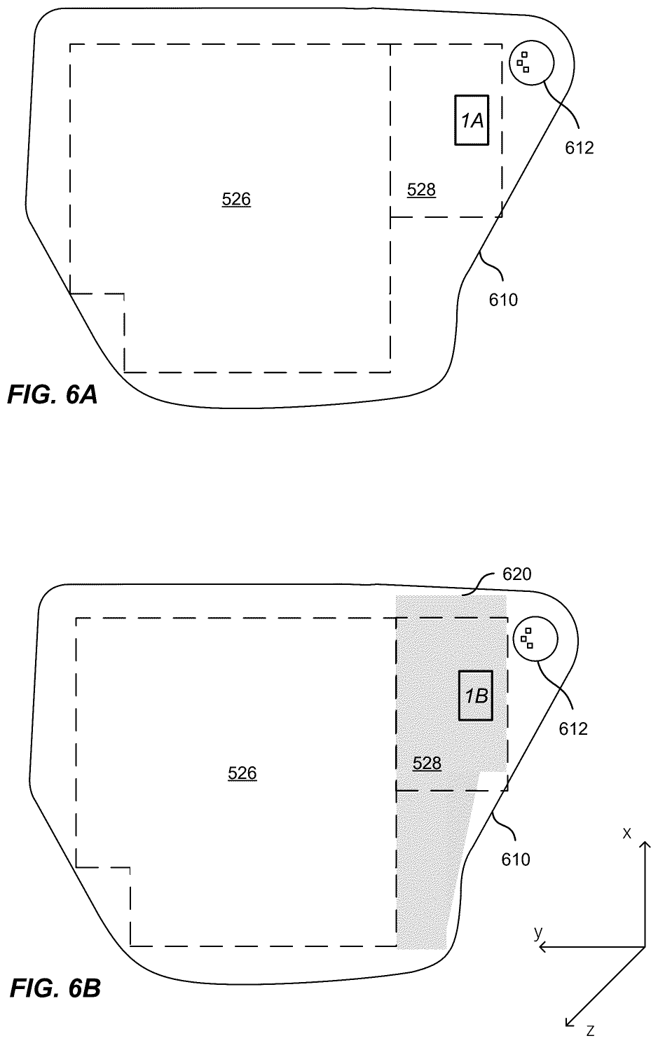

FIG. 6A is a simplified plan view of an eyepiece according to an embodiment of the present invention. As illustrated in FIG. 6A, eyepiece 610 includes incoupling diffractive optical element 612, which incouples image light into eyepiece 610. Referring to FIG. 5A, central region 526 and peripheral region 528 are illustrated in FIG. 6A for reference. World light propagates toward the eyepiece and through both central region 526 and peripheral region 528 and can be viewed by the user in addition to the virtual content produced using the eyepiece. It should be noted that although central region 526 has straight sides, the central region can have a shape that conforms more closely to the eyepiece shape. The central region and the peripheral region are defined in the x-y plane. The light originating behind and to the right of the eyepiece that is reflected from region 1A can be measured and is discussed more fully in relation to Table 1.

To reduce the angular reflection from the eyepiece, some embodiments laminate a circular polarizer to the temple or peripheral side of the eyepiece. The addition of the circular polarizer reduces the amount of light that reaches the user's eye after reflection from the eyepiece. Thus, the addition of the circular polarizer can remove much of the reflected light present in peripheral region 440 of FIG. 4B, restoring the image observed by the user to an image similar to that shown in FIG. 4A. In addition to the use of a circular polarizer to reduce the amount of light reflected in the peripheral region of the eyepiece, other optical elements, including an anti-glare, anti-reflective, tinted (i.e., visible color absorbing) film can be utilized. The color absorptive film can absorb light propagating from behind and to the right of the user and impinging on the eyepiece. By preventing this light from reaching the eyepiece, reflections from the eyepiece can be reduced. As an example, for embodiments utilizing a color absorptive film, the absorption characteristics could vary across the color absorptive film, with higher absorption density at the periphery and decreasing absorption density near the center of the eyepiece. It should be noted that although some of the discussion herein is directed to light originating behind and to the right of the user in the context of light perceived by the user's right eye, similar principles apply to light that originates behind and to the left of the user in relation to the user's left eye. One of ordinary skill in the art would recognize many variations, modifications, and alternatives.

FIG. 6B is a simplified plan view of the eyepiece illustrated in FIG. 6A and a circular polarizer according to an embodiment of the present invention. As illustrated in FIG. 6A, circular polarizer 620 has been added in the peripheral region of the eyepiece, partially or fully overlapping with peripheral region 528. World light propagates toward the eyepiece and through both central region 526 and peripheral region 528 and can be viewed by the user in addition to the virtual content produced using the eyepiece. The light originating behind and to the right of the eyepiece that is reflected from region 1B after making two passes through circular polarizer 620 can be measured and is discussed more fully in relation to Table 1. Generally, the circular polarizer 620 will not overlap with the incoupling diffractive optical element 612 although this is not required by the present invention.

Referring to FIG. 6B, the eyepiece 610 has a world aperture operable to pass world light, represented by central region 526 and peripheral region 528. The circular polarizer 620 overlaps with the world aperture in plan view, i.e., the area covered by circular polarizer 620 in the x-y plane includes at least a part of the area covered by central region 526 and/or peripheral region 528 in the x-y plane. Thus, the term overlap refers to an overlap in the x-y plane when viewed from the z-direction. In other words, the eyepiece is disposed in a lateral plane (i.e., the x-y plane). The eyepiece is operable to pass world light through a world aperture defined by a predetermined area of the lateral plane. In FIG. 6B, the world aperture is represented by central region 526 and peripheral region 528, although the world aperture can include regions of the eyepiece 610 outside central region 526 and peripheral region 528 that transmit world light. The predetermined area of the world aperture includes a lateral position, for example, one of the lateral positions disposed inside peripheral region 528. The circular polarizer 620 is positioned so that a region of the circular polarizer is located at the lateral position. Thus, the circular polarizer 620 shares a common area in the x-y plane with the world aperture. Thus, peripheral region 528, which is a portion of the world aperture, covers a lateral area measured in the x-y plane and circular polarizer 620 is positioned so that the area of the circular polarizer overlaps with at least a portion of the lateral area, which can be the entirety of the lateral area.

It should be noted that in addition to reducing the back reflection of light originating behind the user, the use of the circular polarizer as described herein also reduces the rainbow effect produced in the temple region of the eyepiece, which can result from diffractive optics coupled to a high index of refraction substrates. The rainbow effect can be produced in the user's field of view as a result of world light being incoupled at various angles when this world light interacts with the diffractive optics structure of the waveguide. Thus, embodiments of the present invention enable the peripheral real world field of view to still be visible while reducing back reflections significantly, thereby enabling an increased real world field of view by enhancing the peripheral field of view.

Using a circular polarizer as illustrated in FIG. 6B enables significant reductions in back reflections. Table 1 provides reflection percentage data as a function of angle of incidence for an eyepiece without a circular polarizer positioned in the peripheral region of the eyepiece (Region 1A, see FIG. 6A) and with a circular polarizer positioned in the peripheral region of the eyepiece (Region 1B, see FIG. 6B). To obtain the data illustrated in Table 1, reflectance in region 1A and 1B was measured without a circular polarizer (region 1A) and with a circular polarizer (region 1B). The reflectance was measured in both cases at a variety of angles of incidence ranging from 10° to 60°. As shown in Table 1, the reflectance for an angle of incidence of 10° without a circular polarizer ranges from 8.9% to 37.81%. When the circular polarizer is added as represented by the measurement for region 1B, the reflectance drops significantly, for example, from 8.9% at 10° to 0.21%, which constitutes a reduction in reflectance of 98%.

As shown in Table 1, the integration of the circular polarizer as an element of the eyepiece reduces reflections at various angles by amounts ranging from 71% to 98%.

TABLE 1

| | Angle of Incidence | | | | | |
|---|---|---|---|---|---|---|
| Angle of Incidence (°) | 10° | 20° | 30° | 40° | 50° | 60° |
| Reflectance (%), 1A | 8.9 | 17.48 | 24.9 | 30.52 | 35.01 | 37.81 |
| Reflectance (%), 1B | 0.21 | 0.28 | 0.63 | 1.8 | 4.7 | 11.1 |
| Change | 98%↓ | 98%↓ | 97%↓ | 94%↓ | 87%↓ | 71%↓ |

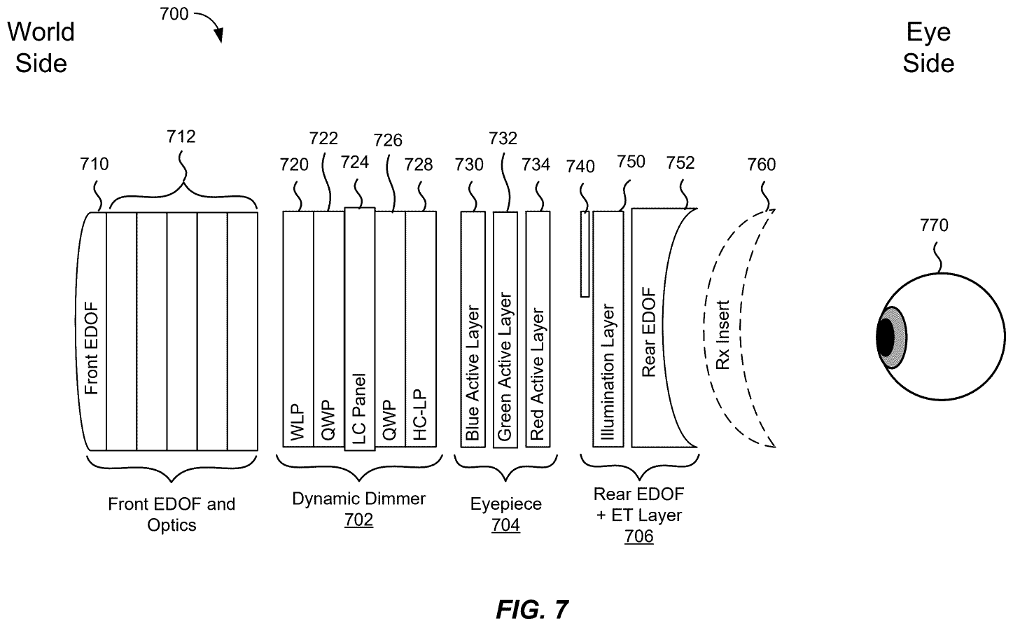

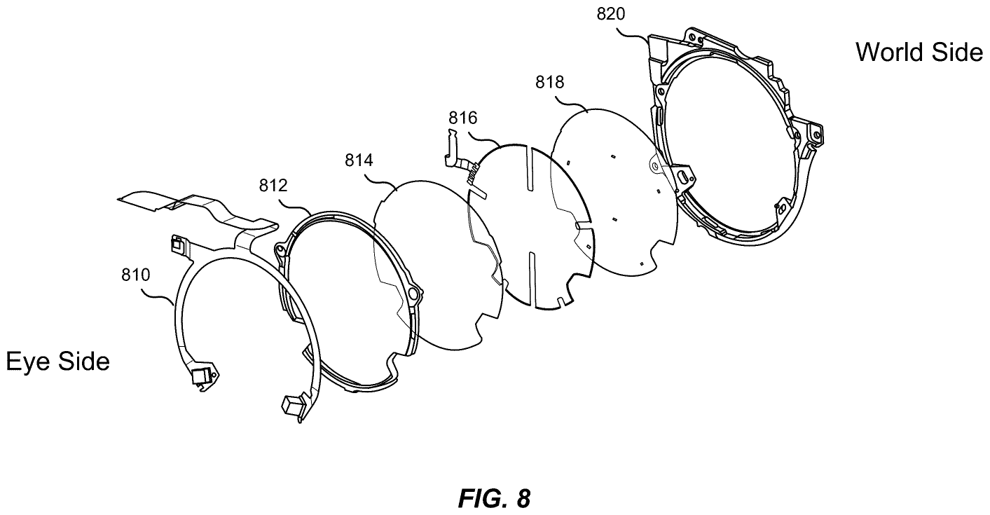

FIG. 7 is a simplified plan view of elements of an AR headset including artifact mitigation according to an embodiment of the present invention. In FIG. 7, elements of a Visible Optics Assembly (VOA) are illustrated. The VOA 700 includes a front Extended Depth Of Field (EDOF) refractive element 710 and front optics 712 that receive world light propagating from left to right toward the eye 770 of the user. The VOA 700 also includes a dimmer 702, an eyepiece 704, rear EDOF and eye tracking (ET) layer 706, and optional prescription lens insert 760. Dimmer 702 includes a world side linear polarizer 720, a first quarter waveplate 722, a liquid crystal panel 724, a second quarter waveplate 726, and an eye side linear polarizer 728, for example, a hard coated linear polarizer (HC-LP) with a surface open to air hard coated for handling purposes. Eyepiece 704 includes three eyepiece waveguide layers: blue active layer 730, green active layer 732, and red active layer 734. Although a three-layer eyepiece (i.e., an eyepiece including three eyepiece waveguide layers) is illustrated in FIG. 7, this is not required and in other embodiments, a six-layer eyepiece structure can be utilized with, for example, two depth planes.

Rear EDOF and ET layer 706 includes rear EDOF 752, illumination layer 750 utilized in eye tracking, and circular polarizer 740. As shown in FIG. 7, circular polarizer 740 is positioned in the peripheral region of the VOA, leaving the central portion of the VOA unobstructed by circular polarizer 740. Because circular polarizer 740 is positioned between eyepiece 704 and illumination layer 750, circular polarizer 740 can be kept free from user handling, dust and manufacturing residues, which can scatter/reflect light. Moreover, design simplicity is achieved since circular polarizer 740 can be laminated onto illumination layer 750 or other suitable elements of the VOA during assembly as discussed more fully in relation to FIG. 8. Although FIG. 7 illustrates an embodiment in which circular polarizer 740 is positioned adjacent illumination layer 750, the circular polarizer can be positioned at other locations within the VOA as discussed more fully in relation to FIG. 8. Additionally, circular polarizer 740 can be a free-standing element of the VOA, laminated to the read EDOF 752, or the like. One of ordinary skill in the art would recognize many variations, modifications, and alternatives.

In some embodiments, the circular polarizer 740 can be replaced with a color absorptive film, for example, a neutral density filter that attenuates light in the peripheral region. The density of the neutral density filter can vary, for example, transitioning from darker at the periphery to lighter nearer the center of the eyepiece. Moreover, an electrochromic element could be utilized in place of the circular polarizer 740, blocking light originating behind the user. As with the neutral density filter, the density of the electrochromic element can vary, for example, transitioning from darker at the periphery to lighter nearer the center of the eyepiece.

In some cases, the circular polarizer can be left handed or right handed, where a left handed circular polarization refers to the electric field of polarized light being rotated anti-clockwise as viewed from the light source. In some cases, the circular polarizer can be replaced with an absorptive linear polarizer. The alignment of the linear polarizer can be such that if polarizers are used in other components of the VOA assembly, for example, as illustrated in FIG. 7, the world light coming from the front of the VOA assembly is not impeded as it propagates toward the user. Also, any surface open to the air for the polarizer can be coated to provide antireflection/antiglare properties.

FIG. 8 is an exploded perspective view of elements of an AR headset including artifact mitigation according to an embodiment of the present invention. Referring to FIG. 8, the rear portion of the viewable optics assembly is illustrated including the rear carrier 820, the merged illumination and refractive layer (MILR) structure described herein, and the camera flex cable 810. The front EDOF to carrier LDA is also illustrated, which is used to space the front EDOF a predetermined distance from the rear carrier. The virtual content output from the output region of the eyepiece propagates through rear carrier 820 toward the user positioned on the eye side of the MILR structure.

In some embodiments, the circular polarizer can be positioned in, but not limited to, the MILR structure adjacent the passivation coating 818, for example, between the passivation coating 818 and the rear carrier 820. In other embodiments, the circular polarizer is positioned between illumination structure 816 and optical element 812, for example, adjacent substrate 814. It will be appreciated that positioning the circular polarizer adjacent the rear carrier 820 allows the circular polarizer to be closer to the eyepiece than in some other designs. This light reflection mitigating film can be laminated to the desired surface for thinner architectures or kept as floating in implementations where space is available.

As illustrated in FIG. 8, a MILR structure is utilized in which the plurality of illumination sources used for eye tracking are provided as elements of an illumination structure 816 and are laminated between a substrate 814 (e.g., a PET film substrate) and a passivation coating 818. The optical element 812 (i.e., the read EDOF) includes a front (i.e., a world side) planar surface and the substrate 814 is bonded to the front planar surface of the optical element 812. This combined MILR structure thus includes the illumination sources in illumination structure 816 as well as optical element 812 and light from the illumination sources in illumination structure 816 passes through optical element 812 before reflecting from the eye of the user. In a lamination process, substrate 814 (e.g., a PET film substrate) is provided and copper traces and contact pads in illumination structure 816 are deposited on the substrate 814. The LEDs are mounted and electrically connected to the contact pads. Subsequently, a passivation coating 818 is applied, for example, in a roll-to-roll process. The substrate/LED/passivation structure is then bonded to the planar surface of the optical element 812 (i.e., the rear EDOF), for example, laminated to the planar surface of the rear EDOF. Accordingly, the illumination sources are positioned on the world side of the rear EDOF opposite the user's eye and propagate through the rear EDOF before reflection from the user's eye.

Optical element 812 has optical power and can also be referred to as an Extended Depth Of Field (EDOF) refractive element since it moves the virtual content plane a predetermined distance away from the user's eye, thereby extending the depth of field. In some embodiments, optical element 812 moves the virtual content by a distance on the order of tens of centimeters. In the embodiment illustrated in FIG. 8, optical element 812 has negative optical power, i.e., it is a negative lens that diverges collimated light received from the eyepiece. Although not shown in FIG. 8, a corresponding front EDOF with the opposite optical power (i.e., positive optical power) is positioned on the world side of the eyepiece in order to counteract the action of optical element 812 with respect to world light. Thus, the illumination light for eye tracking is generated using illumination sources positioned between the front EDOF and optical element 812 illustrated in FIG. 8 and propagates through optical element 812 before impinging on the eye of the user. The set of cameras that detect illumination light reflected from the eye are positioned on the eye side of optical element 812.

During operation, virtual content will pass through the rear carrier 820, the MILR structure including the plurality of illumination sources in illumination structure 816 and optical element 812 toward the user. The illumination light also passes through optical element 812 before reflecting from the eye of the user.

Although in FIG. 8 the eye tracking illumination sources are illustrated as IR LEDs that are laminated to the PET film substrate and emit light toward the eye side, this is not required. In other embodiments, the illumination sources are disposed at locations peripheral to the illustrated copper traces and a waveguiding layer is utilized in the plane in which the copper traces are disposed. In these embodiments, light from the illumination sources propagates in the plane of the waveguiding layer and is outcoupled to provide the eye tracking illumination. The light can be outcoupled using reflective structures, for example, a mirrored surface tilted at ˜45° to the plane of the waveguiding layer, or diffractive structures, for example, vertical outcoupling gratings disposed in or on the plane of the waveguiding layer. Thus, the IR LEDs illustrated in FIG. 8 can be replaced with illumination regions in which eye tracking illumination is output and directed toward the user's eye. One of ordinary skill in the art would recognize many variations, modifications, and alternatives. Additional information related to waveguiding layers is provided in U.S. Pat. No. 11,106,033 and International Patent Application No. PCT/US22/71988, the disclosures of which are hereby incorporated by reference in their entirety for all purposes.

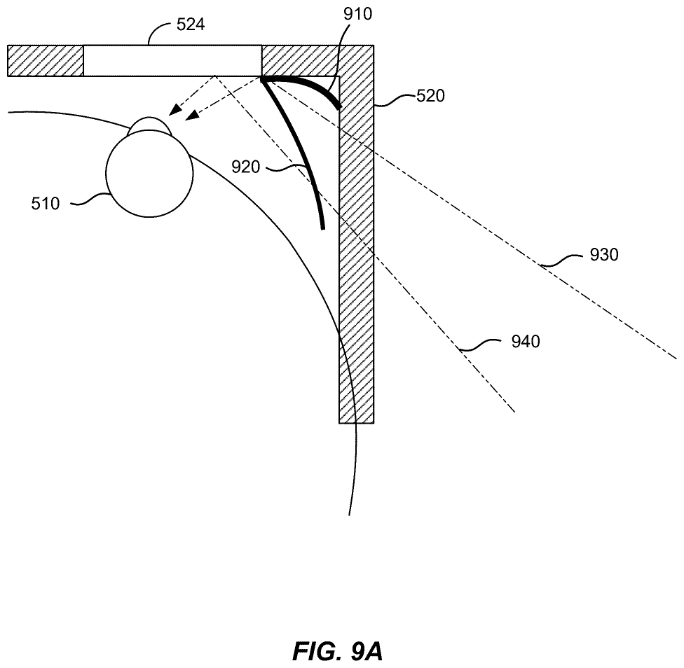

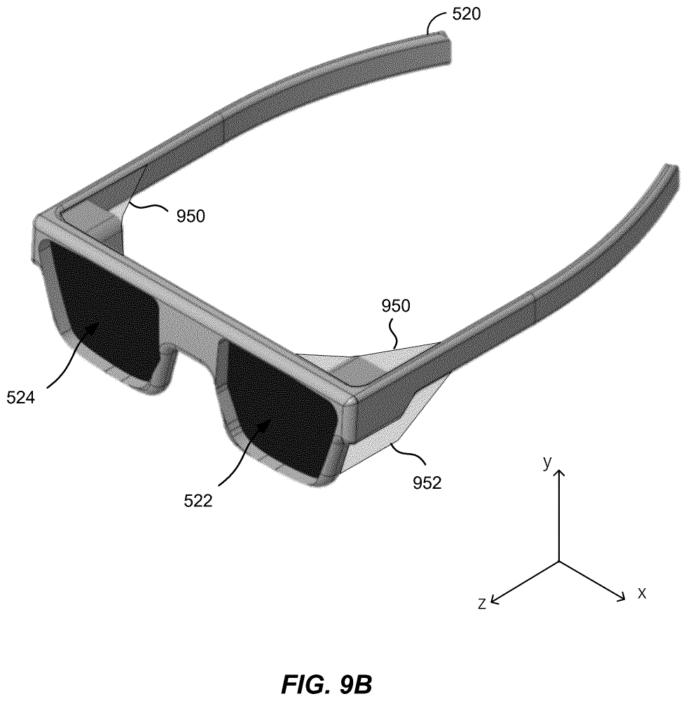

FIG. 9A is a simplified plan view of an AR headset including an attenuating film according to an embodiment of the present invention. As illustrated in FIG. 9A, several embodiments that utilize an attenuating film in order to reduce back reflections are shown. In the plan view illustrated in FIG. 9A, the head of a user is illustrated including right eye 510 with AR headset 520 positioned on the user's head. The AR headset 520 includes right eyepiece 524. In an embodiment, a first attenuating film 910 extends from the temple or peripheral edge of right eyepiece 524 to the temple of the AR headset 520. In another embodiment, a second attenuating film 920 extends from the temple or peripheral edge of right eyepiece 524 to the temple of the AR headset 520. As illustrated in FIG. 9A, light ray 930 would be blocked by first attenuating film 910 (e.g., a neutral density filter), preventing this light from being reflected from the right eyepiece 524 toward the user. Light ray 940 could be blocked by second attenuating film 920 (e.g., a neutral density filter), preventing this light from being reflected from the right eyepiece 524 toward the user. The embodiments illustrated in FIG. 9A related to first attenuating film 910 or second attenuating film 920 block reflections from a wide range of angles and can be utilized in conjunction with a circular polarizer as described herein or in place of a circular polarizer. Additionally, in contrast with embodiments that utilize a circular polarizer, which results in a ˜50% reduction in transmission in the regions of the VOA that contain the circular polarizer, the embodiments illustrated in FIG. 9A do not reduce the intensity of the world light transmitted through right eyepiece 524.

FIG. 9B is a simplified perspective view of an AR headset set including one or more light absorbing films according to an embodiment of the present invention. As illustrated in FIG. 9B, light absorbing film 950 is mounted on AR headset 520 and is disposed in a plane that is generally orthogonal to the plane of the eyepiece. In this example, the left eyepiece 522 and the right eyepiece 524 are disposed in the x-y plane and the light absorbing film 950 is disposed in the x-z plane. Additionally, light absorbing film 952 is mounted on AR headset 520 and is disposed in another plane that is generally orthogonal to the plane of the eyepiece, i.e., the light absorbing film 950 is disposed in the y-z plane. The light absorbing film 950 and the light absorbing film 952 do not have to be orthogonal to the plane of the eyepiece and can be oriented at an angle to the plane of the eyepiece. Light absorbing film 950 and light absorbing film 952 can be color absorptive, photochromic, electrochromic, a linear polarizer, a circular polarizer, or other suitable films. Moreover, light absorbing film 950 and light absorbing film 952 can be positioned on the outside of the AR headset 520 in a manner such that they are detachable through interfaces that can use clips, pins, magnets, or the like. Because, in some embodiments, light absorbing film 950 and light absorbing film 952 are not opaque films, the peripheral real world field of view is not hampered for the user.

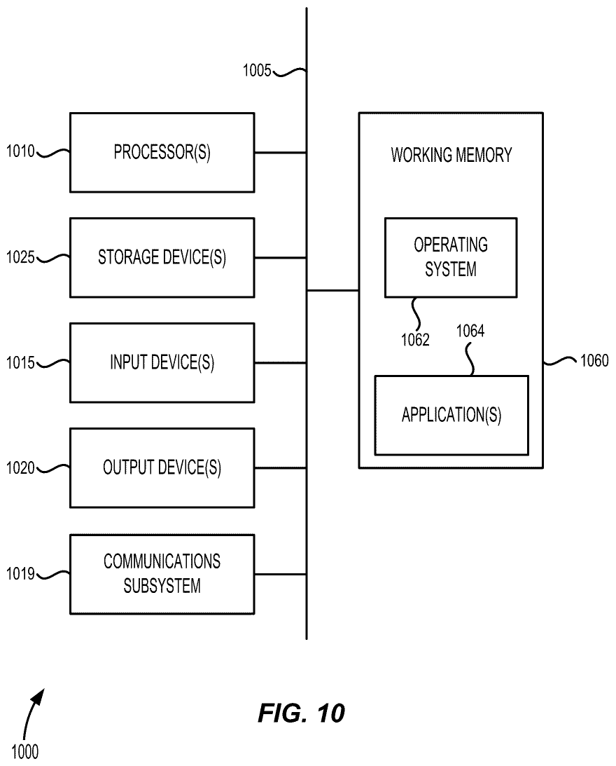

FIG. 10 is a simplified block diagram illustrating components of an AR system according to an embodiment of the present invention. Computer system 1000 as illustrated in FIG. 10 may be incorporated into the AR devices as described herein. FIG. 10 provides a schematic illustration of one embodiment of computer system 1000 that can perform some or all of the steps of the methods provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

Computer system 1000 is shown comprising hardware elements that can be electrically coupled via a bus 1005, or may otherwise be in communication, as appropriate. The hardware elements may include one or more processors 1010, including without limitation one or more general-purpose processors and/or one or more special-purpose processors such as digital signal processing chips, graphics acceleration processors, and/or the like; one or more input devices 1015, which can include without limitation a mouse, a keyboard, a camera, and/or the like; and one or more output devices 1020, which can include without limitation a display device, a printer, and/or the like.

Computer system 1000 may further include and/or be in communication with one or more non-transitory storage devices 1025, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

Computer system 1000 might also include a communications subsystem 1019, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. Communications subsystem 1019 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via communications subsystem 1019. In other embodiments, a portable electronic device, e.g., the first electronic device, may be incorporated into computer system 1000, e.g., an electronic device as an input device 1015. In some embodiments, computer system 1000 will further comprise a working memory 1060, which can include a RAM or ROM device, as described above.

Computer system 1000 also can include software elements, shown as being currently located within working memory 1060, including an operating system 1062, device drivers, executable libraries, and/or other code, such as one or more application programs 1064, which may comprise computer programs provided by various embodiments, and/or may be designed to implement methods, and/or configure systems, provided by other embodiments, as described herein. Merely by way of example, one or more procedures described with respect to the methods discussed above might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as storage device(s) 1025 described above. In some cases, the storage medium might be incorporated within a computer system, such as computer system 1000. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by computer system 1000 and/or might take the form of source and/or installable code, which, upon compilation and/or installation on computer system 1000, e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as computer system 1000 to perform methods in accordance with various embodiments of the technology. According to a set of embodiments, some or all of the procedures of such methods are performed by computer system 1000 in response to processor 1010 executing one or more sequences of one or more instructions, which might be incorporated into operating system 1062 and/or other code, such as an application program 1064, contained in working memory 1060. Such instructions may be read into working memory 1060 from another computer-readable medium, such as one or more of storage device(s) 1025. Merely by way of example, execution of the sequences of instructions contained in working memory 1060 might cause processor(s) 1010 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as storage device(s) 1025. Volatile media include, without limitation, dynamic memory, such as working memory 1060.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by computer system 1000.

Communications subsystem 1019 and/or components thereof generally will receive signals, and bus 1005 then might carry the signals and/or the data, instructions, etc. carried by the signals to working memory 1060, from which processor(s) 1010 retrieves and executes the instructions. The instructions received by working memory 1060 may optionally be stored on a non-transitory storage device 1025 either before or after execution by processor(s) 1010.

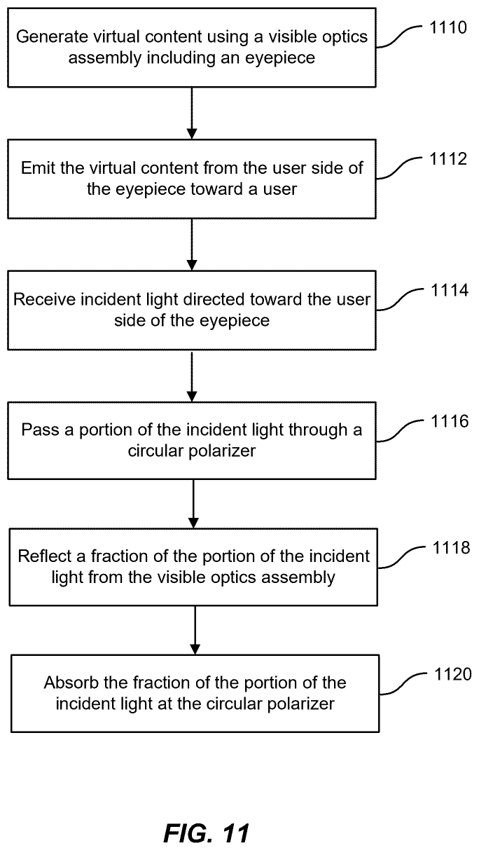

FIG. 11 is a simplified flowchart illustrating a method of operating an AR system according to an embodiment of the present invention. The method is able to mitigate artifacts in an augmented reality headset. The method includes generating virtual content using a visible optics assembly of the augmented reality headset (1110). The visible optics assembly includes an eyepiece having a world side and a user side.

The method also includes emitting the virtual content from the user side of the eyepiece toward a user (1112), receiving incident light directed toward the user side of the eyepiece (1114), and passing a portion of the incident light through a circular polarizer (1116). The eyepiece can have a nasal region and a peripheral region. The circular polarizer can overlap in plan view with the peripheral region. The circular polarizer can be disposed adjacent the user side of the eyepiece. The circular polarizer can include a linear polarizer and a quarter waveplate.

The method further includes reflecting a fraction of the portion of the incident light from the visible optical assembly (1118) and absorbing the fraction of the portion of the incident light at the circular polarizer (1120). As an example, the portion of the incident light can be passed through the circular polarizer at a peripheral region of the eyepiece. Reflecting the fraction of the portion of the incident light from the visible optical assembly can include reflecting the fraction of the portion of the incident light from the eyepiece.

It should be appreciated that the specific steps illustrated in FIG. 11 provide a particular method of operating an AR system according to another embodiment of the present invention. Other sequences of steps may also be performed according to alternative embodiments. For example, alternative embodiments of the present invention may perform the steps outlined above in a different order. Moreover, the individual steps illustrated in FIG. 11 may include multiple sub-steps that may be performed in various sequences as appropriate to the individual step. Furthermore, additional steps may be added or removed depending on the particular applications. One of ordinary skill in the art would recognize many variations, modifications, and alternatives.

In some implementations, the techniques described herein can be performed to form photochromic optical components and/or electrochromic optical components. These optical components can be beneficial, for example, in controlling the amount of light that is transmitted by a VOA, light going through a VOA and light being reflected off the VOA into the user's eye. For example, a VOA having optical components (e.g., dimmers) that are implemented using photochromic optical components and/or electrochromic optical components may have higher light transmissivity and/or reduced thickness compared to VOAs that do not have such optical components (e.g., a VOA having active polarization-based dimmers instead). Nevertheless, in some implementations, VOA can include active polarization-based optical components, either instead or in addition to optical components implemented using photochromic optical components and/or electrochromic optical components.

In general, photochromic optical components (e.g., lenses, waveguides, films, etc.) are optical components that display changes in color or opacity in response to exposure to activating light (e.g., light having a sufficiently high frequency, such as ultraviolet light). For example, upon exposure to activating light, a photochromic optical component may become more opaque, such that light passing through the optical component is attenuated to a greater degree and/or blocked entirely. In the absence of activating light, the photochromic optical component may become less opaque, such that the light passing through the optical component is attenuated to a lesser degree (or is transmitted entirely). In some implementations, photochromic optical components can be configured to selectively attenuate particular wavelengths of light in response to activating light, while substantially transmitting other wavelengths of light (e.g., to selectively alter the color spectra of the transmitted light). In some implementations, photochromic optical components can be formed from materials such as silver halides (e.g., AgCl), diarylethene, dithienylethene, naphthopyrans, and/or oxazines, among other materials.

Further, photochromic materials can be categorized as either T-type or P-type. In general, T-type photochromic materials can undergo thermally reversible photochromism (e.g., T-type photochromic materials may return to their original state upon cessation of the activating light). In contrast, P-type photochromic materials can undergo photochemically reversible photochromism (e.g., P-type photochromic materials may return to their original state upon application of de-activating light having a different wavelength than that of the activating light).

In some implementations, photochromic optical components can be used to control the transmission of light through a VOA, depending on whether the VOA is operated in an environment having lower intensity ambient light (e.g., indoors). For example, a photochromic optical component can be configured such that it is highly transmissive in an environment having low intensity ambient light (e.g., indoors), while having reduced light transmissivity in an environment having high intensity ambient light (e.g., outdoors). This can be beneficial, for example, in presenting content to a user according to a consistent image quality and contrast under various operating conditions.

In some implementations, photochromic optical components can be formed by using one or more photochromic dyes or pigments. For example, when forming an optical component (e.g., a lenses), one or more photochromic dyes or pigments can be added to the precursor materials used to form the optical component in order to impart photochromic properties to the resulting optical component. As another example, one or more photochromic dyes or pigments can be used to form optical layers that are applied on or between other optical components.

Example photochromic dyes or pigments are produced by Yamada Chemical Co. Ltd. (Kyoto, Japan). For instance, example T-type photochromic dyes or pigments include: TPC-0021, TPC-0024, TPC-0033, TPC-0054, TPC-0073, TPC-0062, and TPC-0144. Further, example T-type photochromic dyes or pigments include: DAE-0001, DAE-0004, DAE-0012, DAE-0018, DAE-0068, DAE-0097, DAE-0133, and DAE-0159.

In some implementations, an optical assembly can include one or more layers of photochromic material molded to, adhered to, or otherwise secured to another optical component. For the application of reducing unwanted world light entering into the VOA from the temple region, the photochromatic material can be applied to a flat or curved surface of the rear lens used to give virtual images a focal depth and/or the back lit LED illumination layer for eye tracking. As another example, one or more layers of photochromic material can be molded to, adhered to, or otherwise secured to the world side and/or the user side of the third set of optical elements.

In some implementations, an optical assembly can include one or more optical components formed using photochromic materials (e.g., one or more photochromic dyes or pigments). For example the rear optical lens can be formed partially using photochromic materials in the temple region. As described above, in some implementations, an optical assembly can include one or more layers of photochromic material that are molded to, adhered to, or otherwise secured to another optical component.

As another example, the optical sub-component can be an optically transmissive substrate composed, at least in part, of a photochromic material. As another example, one or more of the optical sub-components can be an optically transmissive substrate that is laminated, adhered to, or otherwise secured to a layer of photochromic material.

As described above, in some implementations, an optical assembly can include one or more optical components formed using photochromic materials. For instance, as described above, an optical sub-component can be formed from a curable prepolymer material. The prepolymer material can include photochromic materials, such as one or more photochromic dyes or pigments mixed into the prepolymer material. In turn, the prepolymer material can be cured into an optical sub-component (e.g., a lens, waveguide, layer, etc.), and laminated to, adhered to, or otherwise secured to another optical sub-component.

In some implementations, the techniques described herein also can be performed to form electrochromic optical components. In general, electrochromic optical components (e.g., lenses, waveguides, films, etc.) are optical components that display changes in color or opacity in response to electrical stimulus. For example, upon receiving an electrical stimulus, an electrochromic optical component may become more opaque, such that light passing through the optical component is attenuated to a greater degree and/or blocked entirely. In the absence of electrical stimulus, the electrochromic optical component may become less opaque, such that the light passing through the optical component is attenuated to a lesser degree (or is transmitted entirely). In some implementations, electrochromic optical components can be configured to selectively attenuate particular wavelengths of light in response to electrical stimulus, while substantially transmitting other wavelengths of light (e.g., to selectively alter the color spectra of the transmitted light).

In some implementations, electrochromic optical components can be formed using transparent conductive electrodes (e.g., indium tin oxide (ITO), conductive polymers, metal nanowire films, etc.), ion storage layers, and/or ion transport layers that perform reduction-oxidation (redox) chemistry on transition metal oxide materials (e.g., IrO₂, V₂O₅, NiO, WO₃, MoO₃, etc. As an example, in one oxidation state these metal oxides may be transparent, and in another they may have significant visible absorption. An electrical stimulation can be selectively applied to (or removed from) the metal oxides (e.g., via the conductive electrodes, ion storage layers, and/or ion transport layers) to selectively switch the metal oxides between the two oxidation states.

In some implementations, electrochromic optical components can be formed using copolymer or mixed oxide systems. For example, a color neutral modulation can be achieved using microelectromechanical systems (MEMS)-based activate layers, including both MEMS-based mirrors and “microblinds” provided on transparent conductive oxides, such as ITO. In some implementations, the microblinds can be thin partially transparent metal strips that are rolled up and fully transparent in an “off” state (e.g., when no electrical stimulus is applied to the transparent conductive oxides), and unroll and at least partially block light when in an “on” state (e.g., when electrical stimulus is applied to the transparent conductive oxides).

This configuration may be particularly advantageous in implementing a segmented dimmer for a VOA, due to a rapid switching time between off and on states (and vice versa) and due to the color neutral modulation of light. For example, a segmented dimmer can include an array of electrochromic optical components arranged in a particular pattern (e.g., a two-dimensional grid perpendicular to the optical axis of the VOA). Each of the electrochromic optical components can be selectively switched to modulate light along different respective portions of the user's field of view.

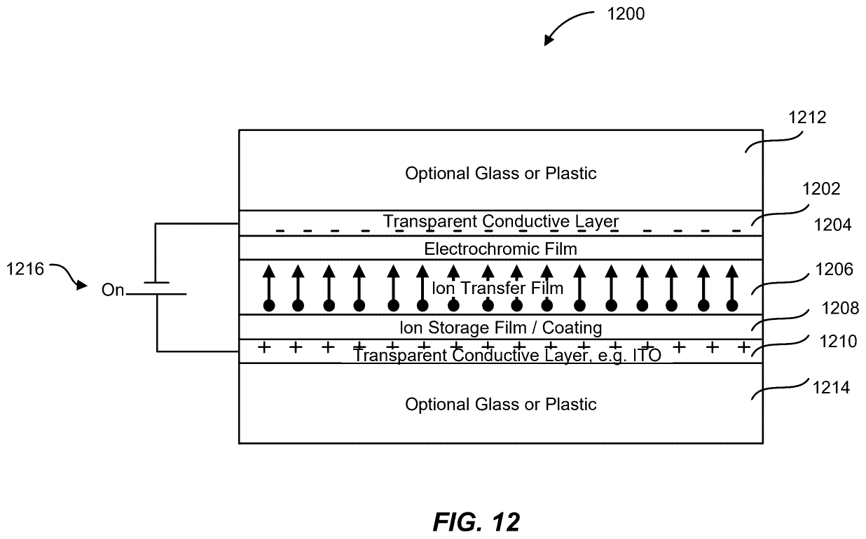

FIG. 12 is a cross sectional view of an exemplary electrochromic optical component 1200 according to an embodiment of the present invention. The electrochromic optical component 1200 includes a first transparent conductive layer 1202, an electrochromic film 1204, an ion transfer film 1206, an ion storage film or coating 1208, and a second transparent conductive layer 1210 arranged in a stack. The electrochromic optical component 1200 can also include glass or plastic layers to protect the electrochromic optical component 1200. For example, electrochromic optical component 1200 can include a glass or plastic layer 1212 on top of the first transparent conductive layer 1202 and/or a glass or plastic layer 1214 below the second transparent conductive layer 1210 to at least partially enclose the electrochromic optical component 1200.

The electrochromic optical component 1200 also includes a voltage source 1216 electrically coupled to the first transparent conductive layer 1202 and the second transparent conductive layer 1210. The voltage source 1216 can be selectively activated or deactivated to change the opacity of the electrochromic optical component 1200.

For example, the voltage source 1216 can apply positive voltage of the second transparent conductive layer 1210 and a negative voltage to the first transparent conductive layer 1202. In response, positively charged electrical ions from the ion storage film or coating 1208 migrate away from the second transparent conductive layer 1210, through the ion transfer film, and into the electrochromic film 1204. The flow of electrical ions electrically stimulates the electrochromic film 1204 and causes the electrochromic film 1204 to change in opacity (e.g., increase in opacity). When the voltage source is switched off or its polarity reversed, the positively charged electrical ions migrate back through the ion transfer film 1206 and into the ion storage film or coating 1208. The reverse flow of electrical ions ceases the electrical stimulation of the electrochromic film 1204, and causes the electrochromic film 1204 to reverse its change in opacity (e.g., decrease in opacity).

In some implementations, first transparent conductive layer 1202 and the second transparent conductive layer 1210 can be formed, at least in part, of ITO. The substrate which sandwiches the Transparent conductive layers (ITO, PEDOT, etc.) can be rigid or flexible inorganic (soda lime, borosilicate, flint glass, Fused Silica, etc.) or organic (PC, PET, TAC, etc.) material.

In some implementations, the electrochromic film 1204 can be formed, at least in part, of a transition metal, such as IrO₂, V₂O₅, NiO, WO₃, MoO₃, etc. In some implementations, the electrochromic film can include MEMS-based activate layers, such as MEMS-based mirrors and microblinds provided on transparent conductive oxides (e.g., ITO). Electrochemically active conjugated polymers such as poly(3,4-ethylenedioxythiophene-didodecyloxybenzene) (PEB). These are viologens, polypyrrole, polythiophene, polyaniline and their derivatives, metal polymers, and metal phthalocyanines. Some other inorganic materials can also be hexacyanometallates in addition to the metal oxides mentioned.

In some implementations, the ion transfer film 1206 can be formed, at least in part, of ion transfer material that is the electrolyte and can consist of solid or liquid material. A good example is Gel electrolytes such as Poly(vinylidene fluoride co-hexafluoropropylene)/Lithium bis(trifluoromethanesulfonyl)imide/PVDF-co-HFP/LiTFSI. In some implementations, the ion storage film or coating 1208 can be formed, at least in part, of Ion storage films that can be formed, for example, with dry deposition of NiO of different porosity, CeO₂, V₂O₅, etc.

In some implementations, an optical assembly can include one or more electrochromic devices (e.g., at least a portion of the electrochromic optical component 1200) molded to, adhered to, or otherwise secured to another optical component. The electrochemical component can block a partial view of the VOA from the user's side towards the temple area that is exposed to the largest amount of world light at high angles causing reflections towards the users which can now be mitigated. For example, one or more electrochromic devices can be molded to, adhered to, or otherwise secured to the world side and/or the user side of the VOA. As another example, one or more electrochromic devices can be molded to, adhered to, or otherwise secured to the world side and/or the user side of the second set of optical elements (nearest the user). As another example, one or more electrochromic devices can be molded to, adhered to, or otherwise secured to the world side and/or the user side of the third set of optical elements (to the world side of the eye tracking assembly).

As described above, in some implementations, an optical assembly can include one or more layers of electrochromic material molded to, adhered to, or otherwise secured to another optical component. In some implementations, an optical component (e.g., a photochromic and/or electrochromic optical component) can have an anti-reflective pattern formed along at least a portion of its exterior surface. For example, an optical component of a VOA (e.g., a photochromic and/or electrochromic surface) can include a nanopattern having a series of repeated gratings formed along at least a portion of its exterior surface. The gratings can be configured to increase the light transmitted through the VOA, and/or to reduce surface reflection of world side light or projected light through the VOA toward the user or back into the waveguide outcoupling elements of the VOA.

In some implementations, the nanopattern can be formed from the same material as the optical component. In some implementations, the nanopattern can be formed from a material different from the optical component (e.g., a material that is applied by inkjet and imprinted over the curvature or planar surface of the optical component).

In some implementations, the optical component can be an electrochromic lens formed from an electrochromic composite material, and the nanopattern can be coated with a conductive material, such as ITO (e.g., using physical vapor deposition (PVD) sputter) to facilitate the flow of ions (e.g., as described above). In some implementations, a coating of conductive material can be formed from hard coasting materials (e.g., SiO₂), blank anti-reflection coatings (e.g., MgF₂, SiO₂, TiO₂), and/or any combinations thereof.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is an augmented reality headset comprising: a frame; and a plurality of eyepiece waveguide displays supported in the frame, wherein each of the plurality of eyepiece waveguide displays includes: a projector; an eyepiece having a world side and a user side, wherein the eyepiece includes one or more eyepiece waveguide layers, each of the one or more eyepiece waveguide layers including an incoupling diffractive optical element and an outcoupling diffractive optical element; a first extended depth of field (EDOF) refractive element disposed adjacent the world side; a dimmer assembly disposed adjacent the world side; a second EDOF refractive element disposed adjacent the user side; and an optical absorber disposed adjacent the eyepiece and overlapping in plan view with a portion of the eyepiece.

Example 2 is the augmented reality headset of example 1 wherein the eyepiece comprises a nasal region and a peripheral region, wherein the portion of the eyepiece is the peripheral region.

Example 3 is the augmented reality headset of claim 2 wherein the nasal region is free of the optical absorber.

Example 4 is the augmented reality headset of example(s) 1-3 wherein the optical absorber is disposed adjacent the user side of the eyepiece.

Example 5 is the augmented reality headset of example(s) 1-4 wherein the optical absorber comprises a circular polarizer including a linear polarizer and a quarter waveplate.

Example 6 is the augmented reality headset of example(s) 1-5 wherein the optical absorber comprises a neutral density filter.

Example 7 is the augmented reality headset of example(s) 1-6 wherein the optical absorber comprises an optical element configured to absorb visible light.

Example 8 is the augmented reality headset of example(s) 1-7 wherein the optical absorber comprises an electrochromic element.

Example 9 is the augmented reality headset of example(s) 1-8 wherein the optical absorber comprises a photochromic element.

Example 10 is the augmented reality headset of example(s) 1-9 wherein the eyepiece has a world aperture operable to pass world light and the optical absorber overlaps with the world aperture in plan view.

Example 11 is the augmented reality headset of example(s) 1-10 wherein: the eyepiece is disposed in a lateral plane and operable to pass world light through a world aperture defined by a predetermined area of the lateral plane, wherein the predetermined area includes a lateral position; and a region of the optical absorber is positioned at the lateral position.

Example 12 is the augmented reality headset of example(s) 1-11 wherein each of the plurality of eyepiece waveguide displays further comprises an illumination layer operable to generate illumination light directed toward the user side.

Example 13 is the augmented reality headset of example 12 wherein the illumination light comprises infrared light.

Example 14 is the augmented reality headset of example 12 wherein each of the plurality of eyepiece waveguide displays further comprises a set of cameras operable to receive imaging light from the user side.

Example 15 is the augmented reality headset of example(s) 1-14 wherein the optical absorber comprises at least one of an antireflection coating or an antiglare coating.

Example 16 is an augmented reality headset comprising: a frame; and a plurality of eyepiece waveguide displays supported in the frame, wherein each of the plurality of eyepiece waveguide displays includes: a projector; an eyepiece having a world side and a user side, wherein the eyepiece includes one or more eyepiece waveguide layers, each of the one or more eyepiece waveguide layers including an incoupling diffractive optical element and an outcoupling diffractive optical element; a first extended depth of field (EDOF) refractive element disposed adjacent the world side; a second EDOF refractive element disposed adjacent the user side; and an optical absorber disposed adjacent the second EDOF refractive element and overlapping in plan view with a portion of the eyepiece.

Example 17 is the augmented reality headset of example 16 wherein the optical absorber is laminated to the world side of the second EDOF refractive element.

Example 18 is the augmented reality headset of example(s) 16-17 wherein the eyepiece comprises a nasal region and a peripheral region, wherein the portion of the eyepiece is the peripheral region.

Example 19 is the augmented reality headset of example 18 wherein the nasal region is free of the optical absorber.

Example 20 is the augmented reality headset of example(s) 16-19 wherein the optical absorber is disposed adjacent the user side of the eyepiece.

Example 21 is the augmented reality headset of example(s) 16-20 wherein the optical absorber comprises a circular polarizer including a linear polarizer and a quarter waveplate.

Example 22 is the augmented reality headset of example(s) 16-21 wherein the eyepiece has a world aperture operable to pass world light and the optical absorber overlaps with the world aperture in plan view.

Example 23 is the augmented reality headset of example(s) 16-22 wherein: the eyepiece is disposed in a lateral plane and operable to pass world light through a world aperture defined by a predetermined area of the lateral plane, wherein the predetermined area includes a lateral position; and a region of the optical absorber is positioned at the lateral position.

Example 24 is the augmented reality headset of example(s) 16-23 wherein each of the plurality of eyepiece waveguide displays further comprises an illumination layer operable to generate illumination light directed toward the user side.

Example 25 is the augmented reality headset of example 24 wherein the illumination light comprises infrared light.

Example 26 is the augmented reality headset of example 24 wherein each of the plurality of eyepiece waveguide displays further comprises a set of cameras operable to receive imaging light from the user side.

Example 27 is a method of mitigating artifacts in an augmented reality headset, the method comprising: generating virtual content using a visible optics assembly of the augmented reality headset, wherein the visible optics assembly includes an eyepiece having a world side and a user side; emitting the virtual content from the user side of the eyepiece toward a user; receiving incident light directed toward the user side of the eyepiece; passing a portion of the incident light through a circular polarizer; reflecting a fraction of the portion of the incident light from the visible optical assembly; and absorbing the fraction of the portion of the incident light at the circular polarizer.

Example 28 is the method of example 27 wherein the portion of the incident light is passed through the circular polarizer at a peripheral region of the eyepiece.

Example 29 is the method of example(s) 27-28 wherein reflecting the fraction of the portion of the incident light from the visible optical assembly comprises reflecting the fraction of the portion of the incident light from the eyepiece.

Example 30 is the method of example(s) 27-29 wherein the eyepiece comprises a nasal region and a peripheral region, wherein the circular polarizer overlaps in plan view with the peripheral region.

Example 31 is the method of example(s) 27-30 wherein the circular polarizer is disposed adjacent the user side of the eyepiece.

Example 32 is the method of example(s) 27-31 wherein the circular polarizer includes a linear polarizer and a quarter waveplate.

Example 33 is the method of example(s) 27-32 wherein the circular polarizer comprises at least one of an antireflection coating or an antiglare coating.

In the foregoing specification, the disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than restrictive sense.

Indeed, it will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Accordingly, the claims are not intended to be limited to the embodiments shown herein, but are to be accorded the widest scope consistent with this disclosure, the principles and the novel features disclosed herein.

What is claimed is:

1. An augmented reality headset comprising:
a frame; and
a plurality of eyepiece waveguide displays supported in the frame, wherein each of the plurality of eyepiece waveguide displays includes:
a projector;
an eyepiece having a world side and a user side, wherein the eyepiece includes one or more eyepiece waveguide layers, each of the one or more eyepiece waveguide layers including an incoupling diffractive optical element and an outcoupling diffractive optical element;
a first extended depth of field (EDOF) refractive element disposed adjacent the world side;
a dimmer assembly disposed adjacent the world side;
a second EDOF refractive element disposed adjacent the user side; and
an optical absorber disposed adjacent the eyepiece and overlapping in plan view with a portion of the eyepiece.

2. The augmented reality headset of claim 1 wherein the eyepiece comprises a nasal region and a peripheral region, wherein the portion of the eyepiece is the peripheral region.

3. The augmented reality headset of claim 1 wherein the optical absorber is disposed adjacent the user side of the eyepiece.

4. The augmented reality headset of claim 1 wherein the optical absorber comprises a circular polarizer including a linear polarizer and a quarter waveplate.

5. The augmented reality headset of claim 1 wherein the optical absorber comprises a neutral density filter.

6. The augmented reality headset of claim 1 wherein the optical absorber comprises an optical element configured to absorb visible light.

7. The augmented reality headset of claim 1 wherein the optical absorber comprises an electrochromic element.

8. The augmented reality headset of claim 1 wherein the optical absorber comprises a photochromic element.

9. The augmented reality headset of claim 1 wherein the eyepiece has a world aperture operable to pass world light and the optical absorber overlaps with the world aperture in plan view.

10. The augmented reality headset of claim 1 wherein:
the eyepiece is disposed in a lateral plane and operable to pass world light through a world aperture defined by a predetermined area of the lateral plane, wherein the predetermined area includes a lateral position; and
a region of the optical absorber is positioned at the lateral position.

11. The augmented reality headset of claim 1 wherein each of the plurality of eyepiece waveguide displays further comprises an illumination layer operable to generate illumination light directed toward the user side.

12. The augmented reality headset of claim 11 wherein each of the plurality of eyepiece waveguide displays further comprises a set of cameras operable to receive imaging light from the user side.

13. The augmented reality headset of claim 1 wherein the optical absorber comprises at least one of an antireflection coating or an antiglare coating.

14. A method of mitigating artifacts in an augmented reality headset, the method comprising:
generating virtual content using a visible optics assembly of the augmented reality headset, wherein the visible optics assembly includes an eyepiece having a world side and a user side;
emitting the virtual content from the user side of the eyepiece toward a user;
receiving incident light directed toward the user side of the eyepiece;
passing a portion of the incident light through a circular polarizer;
reflecting a fraction of the portion of the incident light from the visible optical assembly; and
absorbing the fraction of the portion of the incident light at the circular polarizer.

15. The method of claim 14 wherein the portion of the incident light is passed through the circular polarizer at a peripheral region of the eyepiece.

16. The method of claim 14 wherein reflecting the fraction of the portion of the incident light from the visible optical assembly comprises reflecting the fraction of the portion of the incident light from the eyepiece.

17. The method of claim 14 wherein the eyepiece comprises a nasal region and a peripheral region, wherein the circular polarizer overlaps in plan view with the peripheral region.

18. The method of claim 14 wherein the circular polarizer is disposed adjacent the user side of the eyepiece.

19. The method of claim 14 wherein the circular polarizer includes a linear polarizer and a quarter waveplate.

20. The method of claim 14 wherein the circular polarizer comprises at least one of an antireflection coating or an antiglare coating.
